(19) United States
(12) Patent Application Publication
(10) Pub. No.: US 2007/0193988 A1
(43) Pub. Date: Aug. 23, 2007

(54) Laser Cutting Machine For Trimming, Adding, Punching Or Similar Comprising A Support For The Removable Laser Head Of A Machine Tool Bed

(75) Inventors: Benoit De Joannis De Verclos, Bazarnes (FR); Serge Vrignaud, Hauterive (FR)

Correspondence Address: YOUNG & THOMPSON, 745 SOUTH 23RD STREET, 2ND FLOOR, ARLINGTON, VA, 22202, US

(73) Assignee: 3D INDUSTRIE (SAS), Bazarnes (FR)

(21) Appl. No.: 11/547,811

(22) PCT Filed: Apr. 8, 2005
(86) PCT No.: PCT/FR05/00858

§ 371 Date: Oct. 6, 2006

(30) Foreign Application Priority Data
Apr. 8, 2004 (FR) 0403699

(51) Int. Cl. B23K 26/08; B23K 26/14

(52) U.S. Cl. 219/121.78; 219/121.84

(57) ABSTRACT

The invention relates to a laser cutting device for trimming, adding, punching and similar a part consisting of a laser cutting head (1) supplied by an optical fibre (7) connected to a laser beam generator (8), wherein said laser cutting head (1) is fixed to a removable support (2) fixable to the bed (3) or the lower and/or top tool holder (5) of a machine tool and is provided with independent and programmable control means for the laser cutting head (1).

This present invention concerns a machine tool of the embossing press type equipped with a laser device for the cutting out, sculpting, embossing, or similar, of a pressed-plate part created by a press tool.

In the area of the shaping of parts, we are quite familiar with machine-tools called stamping or embossing presses that include a machine bed and upper and/or lower tool-holders supported by the bed and respectively receiving stamps and/or dies, with the said tool-holders being respectively made to rise and fall in a vertical direction by any appropriate means. The upper and lower tool holders are controlled by a workstation for example. According to the complexity of the part to be produced, the production lines usually include three or four machine-tools, each of which effect the different operations necessary for the creation of the part, such as cutting out, sculpting or “slotting”.

In order to improve the capabilities of these automatic machine-tools, and to create holes of wide or irregular shape in the part, it has already been proposed to equip these machine-tools with plasma cutting resources, but such plasma cutting devices have the drawback of creating of wide gashes, rough cut edges, and deformation of the part, due to the heat of the plasma close to the cutting line.

In order to overcome these drawbacks, it has already been proposed to replace these plasma cutting devices with laser cutting devices. This is the case, for example, of European patent EP 0 008 773 concerning a stamping or embossing press with a laser-beam cutting head. The laser cutting head is movable vertically, and is supported by a horizontal arm that is fixed in relation to the bed, to the workstation, and to the stationary part of the work table of the stamping or embossing press. The laser cutting head is equipped, in its upper part, with a hollow point, and with an optical device for focussing the beams, with the said device being movable in a vertical direction with the cutting head. The laser cutting head is connected by an optical guide to a laser beam generator located at a distance from the rest of the stamping or embossing press, in such a manner that the generator is not subjected to any vibration. Obviously, the stamping or embossing press also includes a control desk which is used alternately to control an embossing operation and a cutting operation with the laser, by means of the automatic centralised controls on the stamping or embossing press.

This type of machine-tool is intended particularly for long-run mass production of one specific part, so that it has the disadvantage of being difficult to adapt for the production of different parts.

One of the objectives of the invention is therefore to overcome this disadvantage by proposing a machine toll equipped with a laser cutting device of simple design and low cost, and which is adaptable to the machine-tool of the stamping or embossing press type, allowing the cutting to be adapted according to a particular model of part and to its evolution.

To this end, and according to the invention, a machine tool of the embossing type is proposed, which includes a bed, an upper or lower tool holder, and a laser cutting device for the purpose of cutting out, sculpting, stamping or similar operations on a part, with the said device including a laser beam generator, an optical fibre, and a laser cutting head fed from the optical fibre connected to the laser beam generator, and resources to control the laser cutting head that are independent and programmable, and which is notable in that the laser cutting head is attached to a movable support designed to be attached to the bed or the upper or lower tool-holder of a press tool on the said machine tool, to be moved and positioned in accordance with the press tools and the parts to be produced.

It can be seen that, contrary to the devices of previous design in which the laser cutting device is fixed to the bed of the press tool, the cutting device of the machine tool according to the invention can be moved and positioned successively on different press tools, depending on the parts to be produced.

According to an essential characteristic of the machine tool of the invention, the control resources for the cutting head consist of an electronic card attached to the support of the said laser cutting head, and that includes at least storage resources, processing resources and resources for receiving the cutting data of the part, which are transmitted by a PC type desktop computer or by a second cutting device according to the invention.

Other advantages and characteristics will emerge more clearly from the description that follows of the machine tool according to the invention, provided here by way of a non-limiting example, with reference to the appended drawings in which:

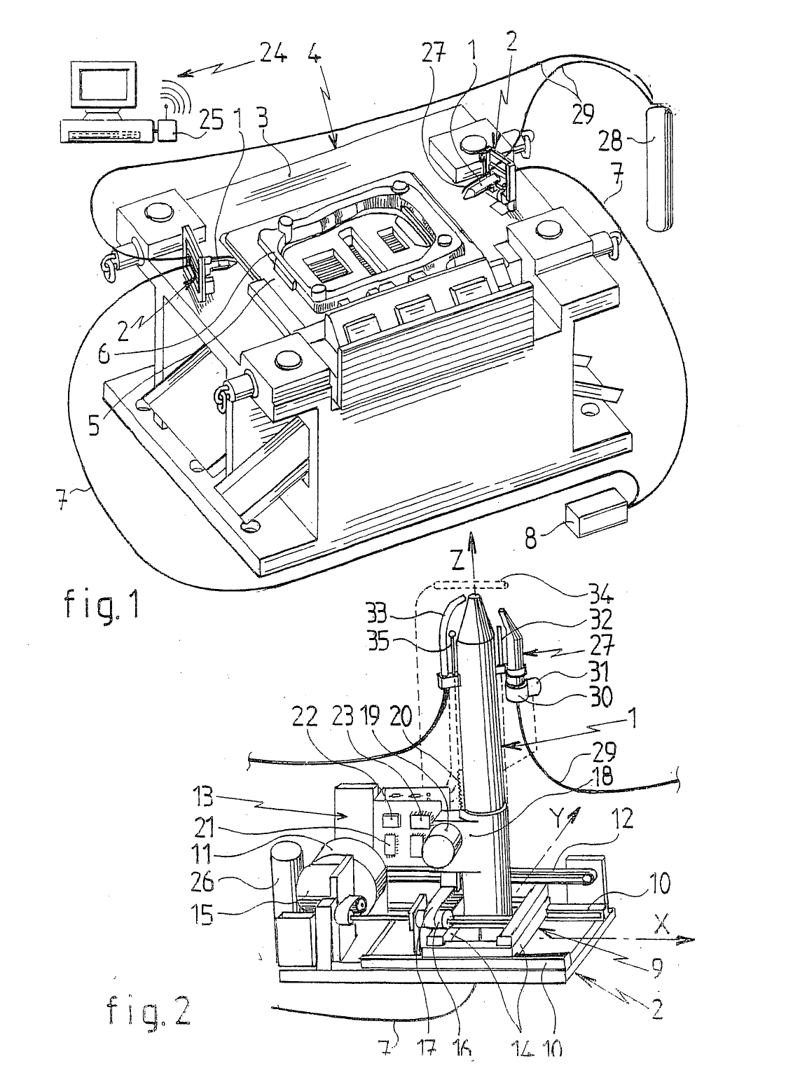

FIG. 1 is a view in perspective of a machine tool,

FIG. 2 is a view in perspective of the laser cutting device.

Referring to FIG. 1, the laser cutting device of the machine tool 4 according to the invention is composed of a laser cutting head 1 attached to a removable support 2 designed to be attached to the bed 3 of the said machine-tool 4 of the stamping or embossing press type, of which only the lower tool-holder 5 fitted with a stamp 6 is represented in FIG. 1. The laser cutting head 1 is fed from an optical fibre 7 connected to a laser beam generator 8 positioned sufficiently far from the stamping or embossing press in order to prevent vibrations from the latter being transmitted to the laser beam generator 8, since these vibrations are liable to disrupt the emission of the laser beams and, as a consequence, to disrupt the laser cutting of the part. The optical fibre 7 is advantageously protected by a rubber sheath reinforced by three to five layers of steel wire according to the flexibility necessary for the optical fibre 7. In addition, the optical fibre 7 is preferably fixed to the laser cutting head 1 by means of well-secured connectors, not shown in FIG. 1.

It is quite obvious that the movable support 2 on which the laser cutting head 1 of the machine tool of the invention is fixed, can be positioned on the upper tool-holder and/or the lower tool-holder of the stamping or embossing without moving outside of the scope of the invention.

The laser beam generator 8 consists, for example, of a diode-bar pumped laser source generating a pulsed or continuous laser beam. The laser cutting head 1 is conventionally composed of a collimation lens, a focussing lens, and a cutting nozzle allowing the concentration at a single point, called the “focus point”, of the laser beam produced by the laser beam generator and transmitted to the said cutting head 1 by the optical fibre 7. All of the energy of the laser beam 8 is concentrated at the focus point, thus allowing the melting and then the vaporisation of the material at this point.

The movable support 2 of the laser cutting device, with reference to FIG. 2, is composed of a carrier 9 on which the laser cutting head 1 is mounted, with the said carrier 9 sliding along two parallel rails 10 lying along a first direction X. The carrier 9 is moved along the rails 10 in direction X by an electric motor 11 driving in rotation, at the end of its output shaft, a toothed gear wheel meshing with a toothed belt 12 in order to drive the carrier 9 in translation along the said rails 10. The electric motor 11 attached to the support 2 is positioned close to the rails 10 of the carrier 9 and is operated by control resources 13 which also control the laser cutting head 1 as will be described later.

In addition, the carrier 9 slides along a second set of rails 14 lying parallel along a direction Y at right angles to direction X of the first rails 10, with the said carrier 9 being driven along these second rails 14 by a second electric motor 15 driving in rotation a toothed gear wheel 16 and a toothed belt 17. This second electric motor 15 is also attached to the support 2, positioned close to the rails of the carrier and operated by the control resources 13.

In order to allow the cutting out of parts in three dimensions, the carrier 9 advantageously includes a post 18 lying at right angles to the rails 10, 14 along axes X and Y respectively and along which the laser cutting head 1 is slid by actuating resources attached to the support 2 positioned close to the rails 10, 14 of the carrier 9 and operated by the control resources 13. These actuating resources consist, for example, of a third electric motor 19 operated by the control resources 13 and meshing with a rack device 20.

The control resources 13 of the electric motors 11, 15, 19 driving the carrier 9 along the different axes X, Y and Z of the cutting device consist of an electronic card attached to the support 2, which also includes storage resources for the data 21, processing resources for the data 22 and resources for receiving the data 23. Here data refers to the cutting-out parameters of the part, namely the cutting-out geometry, the position of the cutting-out geometry in relation to the volume of the part, the thickness of the material, the presence or the absence of a coating on the part, the cutting quality, the triggering of the cutting out process in relation to the press stamping or embossing cycle and the kinetics of the tool, etc. These parameters are supplied by a computer 24 of the PC type, fitted with a radio transmitter 25 which sends the said data by radio to the radio receiver forming the reception resources 23 of the control resources 13, which then store these parameters in the data storage resources 21 of the electronic card, consisting of electronic memory components, with the said parameters then being processed by a processor forming the processing resources 22 which then control the laser cutting head 1 and the different electric motors 11, 15, 19 of the cutting device.

It is quite obvious that the transmission of the data can be effected between the computer 24 and the cutting device of the invention by a communication cable like an RS 232, USB, IEEE 1394 or parallel cable whose ends are respectively connected to the computer 24 and to the electronic card forming the control resources 13 of the device.

In a particularly advantageous manner, the control resources 13 include transmission resources 26 for the data, such as a radio transmitter capable of transmitting the data corresponding to the parameters for cutting-out of the part to the control resources of a second cutting device attached to the bed 3 of the same machine-tool or of another machine-tool.

In order to improve the effectiveness of the cutting-out laser, the device of the machine tool of the invention, with reference to FIGS. 1 and 2, includes a gas-projection nozzle 27 fed by a pressurised gas source 28 operated by the control resources 13. The nozzle 27 is by a flexible tube 29 connected to the compressed-gas source 28 which consists, for example, of a compressed-air bottle. The pressurised-gas projection nozzle 27 is advantageously conical and oriented in the direction of the focus point the laser cutting head 1 in order to remove the metal vaporised by the laser beam. In order to allow adjustment of the pressure of the compressed gas, the device advantageously includes a mechanical shut-off valve 30 operated by a stepping micro-motor 31 operated by the control resources 13, which adjust the pressure according to the pressure measured by a pressure sensor 32 positioned close to the said nozzle 27 and connected to the control resources 13.

In addition, in order to prevent any deposition of material on the laser cutting head 1, the device advantageously includes a second compressed-air projection nozzle 33 connected to the compressed-air source 28, oriented in the direction of the laser cutting head 1 and operated by the control resources 13.

According to one execution variant, the device can advantageously include a mechanical shut-off valve 34, shown by broken lines in FIG. 2, positioned at the output of the laser cutting head 1 between the latter and the part to be cut out, and operated by the control resources 13 in order to prevent any deposition of material on the said cutting head 1 when the latter is positioned under the part to be cut out. This mechanical shut-off valve 34 is then driven by a micro-motor operated by the control resources 13, connected to a part-presence sensor 35. Thus, the presence sensor for the part to be cut out allows the control resources 13 to close the mechanical shut-off valve 34 in order to protect the cutting head 1 when the part is removed either by gravity or by mechanical assistance from a push device thus preventing any waste from falling onto the cutting head 1 during removal of the part. It can be seen that this presence sensor 35, which consists, for example, of a differential pressure sensor, an optical sensor or an electronic sensor, also allows the control resources 13 to prevent any cutting out cycle by means of the laser cutting head 1 to take place in the absence of a part in the stamping or embossing press.

It goes without saying that the laser cutting device can be secured in a removable manner on a fixed part such as the bed of the machine-tool, or on a mobile part such as the lower tool-holder and/or the upper tool-holder of the machine-tool of the invention, by any appropriate means such as pins, adhesive, or similar.

In addition, it is quite obvious that several laser cutting devices can be positioned on the machine-tool of the invention, with each of the devices being capable of communicating with one or more other neighbouring devices, where the latter are all fed by the same laser beam generator 8.

In addition, the device of the machine tool can advantageously include a protective enclosure covering the support 2, the cutting head 1, the carrier 2, the control resources 13, etc., where the said enclosure includes an opening for the passage of the cutting head 1 and of the nozzles 27, 33.

Finally, it goes without saying that the examples that have just been given are only particular illustrations, which in no way limit the areas of application of the invention concerned.

1-14. (canceled)

15. A machine tool (4) of the stamping or embossing press type, including a bed (3), an upper or lower tool holder (5) and a laser cutting device for the cutting out, sculpting, embossing or similar, of a part, where the said device includes laser beam generator (8), an optical fibre (7) and a laser cutting head (1) fed from the optical fibre (7) connected to the laser beam generator (8), and control resources (13) for the laser cutting head, which are independent and programmable, characterised in that the laser cutting head (1) is attached to a movable support (2) designed to be attached to the bed (3) or the upper or lower tool-holder (5) of the said machine-tool (4), to be moved and positioned in accordance with the press tools and the parts to be produced.

16. A machine tool (4) according to claim 15, characterised in that the support (2) includes a carrier (9) holding the laser cutting head (1) and slid along rails (10, 14) lying along at least two axes (X and y) by actuating resources (11, 15) attached to the support (2), positioned close to the rails (10, 14) of the carrier (9) and operated by the control resources (13).

17. A machine tool (4) according to claim 16, characterised in that the laser cutting head (1) is slid along a post (18) located at right angles to the rails (10, 14) along axes X and Y, by actuating resources (19) attached to the support (2), positioned close to the rails (10, 14) of the carrier (9) and operated by the control resources (13).

18. A machine tool (4) according claim 15, characterised in that the support (2) includes at least one sensor (32, 35) connected to the control resources (13).

19. A machine tool (4) according to claim 18, characterised in that the sensor (35) consists of a presence sensor for the part, so as to stop the cutting cycle in the absence of a part in the press tool.

20. A machine tool (4) according to claim 15, characterised in that the optical fibre (7) is covered by a rubber sheath.

21. A machine tool (4) according to claim 15 characterised in that the control resources (13) consist of an electronic card that includes at least storage resources (21), processing resources (22) and reception resources (23) for the data.

22. A machine tool (4) according to claim 21, characterised in that the control resources (13) include data transmission resources (26) suitable for transmission of the data to the control resources (13) of a second cutting device.

23. A machine tool (4) according to claim 15, characterised in that the support (2) includes a nozzle for the projection (27) of a gas, fed by a pressurised gas source (28) operated by the control resources (13).

24. A machine tool (4) according to claim 23, characterised in that the gas consists of compressed-air.

25. A machine tool (4) according to claim 23, characterised in that the projection nozzle is oriented in the direction of the focus point of the laser cutting head (1), in order to remove the metal vaporised by the laser beam.

26. A machine tool (4) according to claim 15, characterised in that it includes a second gas projection nozzle (33), fed from a pressurised gas source (28), operated by the control resources (13) and oriented in the direction of the laser cutting head (1) in order to prevent any deposition of material on the said laser cutting head (1).

27. A machine tool (4) according to claim 23, characterised in that it includes resources to vary the pressure of the gas jet escaping from the first projection nozzle (27).

28. A machine tool (4) according to claim 15, characterised in that it includes a mechanical shut-off valve (34) positioned at the output of the laser cutting head (1), between the latter and the part to be cut out, and operated by the control resources (13).

29. A machine tool (4) according to claim 24, characterised in that the projection nozzle is oriented in the direction of the focus point of the laser cutting head (1), in order to remove the metal vaporised by the laser beam.

30. A machine tool (4) according to claim 24, characterised in that it includes resources to vary the pressure of the gas jet escaping from the first projection nozzle (27).
